(19) United States
(12) Patent Application Publication
(10) Pub. No.: US 2022/0247196 A1
(43) Pub. Date: Aug. 4, 2022

(54) SCHEDULE-BASED CHARGING OF BATTERIES

(71) Applicant: Hewlett-Packard Development Company, L.P., Spring, TX (US)

(72) Inventors: Hassan A. Syed, Spring, TX (US); Juan Martinez, Spring, TX (US); Benson C. Lim, Spring, TX (US)

(73) Assignee: Hewlett-Packard Development Company, L.P., Spring, TX (US)

(21) Appl. No.: 17/415,760

(22) PCT Filed: Jul. 22, 2019
(86) PCT No.: PCT/US2019/042779

§ 371 Date: Jun. 18, 2021

(51) Int. Cl. H02J 7/00; H01M 10/44

(52) U.S. Cl. CPC H02J 7/0071; H01M 2220/30; H01M 10/44; H02J 7/007188

(57) ABSTRACT

In some examples, a controller includes a processing resource and a memory resource storing instructions to cause the processing resource to determine a schedule associated with a user identity, and cause, in response to an appointment included on the schedule associated with the user identity, a rechargeable battery of a computing device to charge from a first charge capacity to a second charge capacity.

### BACKGROUND

Computing devices can utilize a battery in order to function when not connected to a power source. The battery can provide power to a computing device when the computing device is not connected to a power source, during which time the charge capacity in the battery is depleted. When the computing device is connected to a power source, the power source can provide power to the computing device, as well as charge the battery so that the battery can provide power to the computing device when the computing device is disconnected from the power source.

### BRIEF DESCRIPTION OF THE DRAWINGS

FIG. 1 illustrates an example of a computing device for schedule-based charging of batteries consistent with the disclosure.

FIG. 2 illustrates an example of a controller for schedule-based charging of batteries consistent with the disclosure.

FIG. 3 illustrates a block diagram of an example system consistent with the disclosure.

FIG. 4 illustrates an example of a method for schedule-based charging of batteries consistent with the disclosure.

### DETAILED DESCRIPTION

A computing device can utilize a battery to power the computing device when the computing device is not connected to a power source. The battery can be recharged when the computing device is connected to a power source. As used herein, the term “battery” refers to a device having an electrochemical cell with external connections to provide power to electrical devices. For example, the electrochemical cells in a battery can provide power to a computing device.

As used herein, the term “computing device” can be, for example, a laptop computer, a notebook computer, a desktop computer, and/or a mobile device (e.g., a smart phone, tablet, personal digital assistant, smart glasses, a wrist-worn device, etc.), among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

As described above, a battery may be recharged when power is depleted from the electrochemical cell included in the battery. As used herein, the term “rechargeable battery” refers to a battery which can be charged, discharged into an electrical load (e.g., an electrical device), and recharged again. For example, a rechargeable battery may discharge power from electrochemical cells included in the rechargeable battery (e.g., to a computing device), and be recharged so that the rechargeable battery may again be able to discharge power from the electrochemical cells.

As used herein, the term “charge capacity” refers to an amount of charge stored in a battery. As used herein, the term “full charge capacity” refers to a total amount of charge capacity included in a battery. Some rechargeable batteries may lose charge capacity over time. For example, charging a rechargeable battery to a full charge capacity and maintaining the full charge capacity for a period of time can stress the rechargeable battery. In some examples, as a rechargeable battery is charged and/or discharged, the total amount of charge capacity of the rechargeable battery when manufactured and/or the full charge capacity of the rechargeable battery may diminish over the life cycle of the rechargeable battery.

By scheduling charging of batteries, the degree of diminished capacity may be able to be limited, for example. Schedule-based charging of batteries, according to the disclosure, can allow for a battery to be charged to a charge capacity that is less than a full charge capacity when a user does not have any appointments on a schedule. Charging the battery to a charge capacity that is less than a full charge capacity can prolong a lifespan of a rechargeable battery. Accordingly, when a user does have an appointment on a schedule, the rechargeable battery can be charged to a full capacity to allow the user to utilize the full charge capacity of the rechargeable battery associated with the user's computing device.

FIG. 1 illustrates an example of a computing device 102 for schedule-based charging of batteries consistent with the disclosure. The computing device 102 can include a rechargeable battery 104 and a controller 106.

As illustrated in FIG. 1, the computing device 102 can include a rechargeable battery 104. As described above, the computing device 102 can utilize the rechargeable battery 104 in instances where the computing device 102 is not connected to the power source 108. For example, when a user takes the computing device 102 to an appointment where a power source is not available, the rechargeable battery 104 can power the computing device 102. When the power included in the rechargeable battery 104 has depleted, a user may reconnect the computing device 102 to a power source to charge the rechargeable battery 104.

In some examples, the rechargeable battery 104 can be a lithium-ion battery. However, examples of the disclosure are not so limited. For example, the rechargeable battery 104 can be any other type of rechargeable battery.

As illustrated in FIG. 1, the computing device 102 can be connected to the power source 108. As used herein, the term “power source” refers to a device that supplies electrical power to another device. For example, the power source 108 can be an alternating-current (AC) power source, a direct-current (DC) power source, wireless power sharing power source, etc.

As described above, the rechargeable battery 104 can be charged according to a schedule, as is further described herein. Accordingly, the controller 106 can determine a schedule associated with a user identity. As used herein, the term “user identity” refers to a logical entity to identify a user in a computing environment. For example, a user identity can be a unique string of characters that can identify a user in, for instance, a software system.

The user identity can be associated with a schedule. As used herein, the term “schedule” refers to an event or a collection of events to occur at or during a particular time or period. For example, a schedule can include an appointment which is to occur at a particular time and/or place. As used herein, the term “appointment” refers to an event set for a specific time and/or place. For example, the appointment can be for a meeting set for a specific time (e.g., 10 AM) and/or for a specific place (e.g., a specified location). The appointment can be, for instance, a business meeting, personal appointment, and/or any other event which can be set for a specific time and/or place.

The schedule may be included in scheduling software. For example, the schedule can be a collection of events to occur at or during a particular time or period, where the collection of events can be stored in a database as text, logs, a website, an application on a mobile device (e.g., a smart phone), and/or any other type of data structure that can be retrieved from the database and used to determine a battery charging schedule. The scheduling software may be located local to the computing device 102 and/or remote from the computing device 102. For example, the scheduling software may be located locally on the computing device 102 and the user identity can be associated with the computing device 102. In some examples, the scheduling software may be located remotely from the computing device 102 (e.g., via a remote server and/or cloud computing server) and the user identity can be associated with a particular instance of the scheduling software located on the remote server and/or cloud computing server. In such an example, a user identity can be associated with multiple devices (e.g., the computing device 102, a mobile device such as a smart phone being connected with the remote server and/or cloud computing server, etc.).

While the controller 106 is illustrated in FIG. 1 as being included in computing device 102, examples of the disclosure are not so limited. For example, the controller 106 may be located remote from the computing device 102 and can communicate with the computing device 102 via a network relationship. For example, the controller 106 may communicate with the computing device 102 via a wired or wireless network.

The wired or wireless network connection can be a network relationship that connects the controller 106 with the computing device 102. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WIMAX), infrared (IR) communication, Public Switched Telephone Network (PSTN), radio waves, and/or the Internet, among other types of network relationships

The controller 106 can determine a schedule associated with a user identity of a user. For example, a user may have appointments on the user's associated schedule in various locations throughout the day. For instance, the controller 106 can determine that the user has a first appointment at 10 AM, where the first appointment is a phone conference call the user is to dial in from at the user's workstation, and a second appointment at 12 PM, where the second appointment is in a conference room.

In some examples, the controller 106 can determine whether the appointment is in a location without a power source. For example, the controller 106 can determine that the first appointment is at the user's workstation, which includes a power source (e.g., power source 108), and that the second appointment is in a conference room that is located away from the power source 108. Accordingly, the controller 106 can determine that the second appointment (e.g., at 12 PM) may be in a location without a power source.

The controller 106 can cause, in response to an appointment included on the schedule associated with the user identity, the rechargeable battery 104 of the computing device 102 to charge from a first charge capacity to a second charge capacity. The second charge capacity can be greater than the first charge capacity. For example, the second charge capacity can correspond to a full charge capacity of the rechargeable battery 104. Accordingly, the controller 106 can cause the rechargeable battery 104 to charge to 100% charge capacity (e.g., the second charge capacity) in response to the appointment being included on the schedule. The computing device 102 can be powered by the power source 108 while the controller 106 causes the rechargeable battery 104 to be charged (e.g., by the power source 108) to the second charge capacity.

In some examples, the first charge capacity can be a threshold charge capacity that is less than the full charge capacity of the rechargeable battery 104. For example, as described above some rechargeable batteries may lose charge capacity when charging a rechargeable battery to full charge capacity and maintaining the full charge capacity for a period of time. Accordingly, the first charge capacity can be a threshold charge capacity (e.g., 85% charge capacity). That is, while the computing device 102 is connected to the power source 108, the controller 106 can cause the rechargeable battery 104 to charge to the first charge capacity (e.g., 85% charge capacity), and then prevent the rechargeable battery 104 from charging to the second charge capacity until an appointment is included on the schedule associated with the user identity such that the controller 106 causes the rechargeable battery 104 to charge to the second charge capacity.

Although the threshold charge capacity is described above as being 85% charge capacity, examples of the disclosure are not so limited. For example, the threshold charge capacity can be less than 85% (e.g., 80%) or more than 85% (e.g., 90%).

Additionally, although the threshold charge capacity is described above as being a particular charge capacity percentage, examples of the disclosure are not so limited. For example, the threshold charge capacity can include a range of charge capacities. For instance, the first charge capacity may be a charge capacity range (e.g., 75% to 85% charge capacity). That is, while the computing device 102 is connected to the power source 108, the controller 106 can cause the rechargeable battery 104 to charge to the first charge capacity included in the charge capacity range (e.g., 80%), and then prevent the rechargeable battery 104 from charging to the second charge capacity until an appointment is included on the schedule associated with the user identity such that the controller 106 causes the rechargeable battery 104 to charge to the second charge capacity.

In some examples, the first charge capacity can be an intermediate charge capacity. For example, the computing device 102 may have been disconnected from the power source 108 (e.g., a user may have been carrying the computing device 102 with them around a workplace) while the rechargeable battery 104 powers the computing device 102. Accordingly, a user may connect the computing device 102 to the power source 108 such that the intermediate charge capacity of the rechargeable battery 104 is at 40%. The controller 106 can cause the rechargeable battery 104 to charge to the second charge capacity (e.g., the full charge capacity) from the first charge capacity (e.g., 40%, the intermediate charge capacity) in response to an appointment being included on the schedule associated with the user identity. In an example in which no appointments are included on the schedule, the controller 106 can cause the rechargeable battery 104 to charge to a threshold charge capacity (e.g., 85%, as described above) until there is an appointment determined to be included on the schedule.

In some examples, the appointment may be in location with a power source (e.g., power source 108). In such an example, the controller 106 can cause, in response to the appointment being at a location with a power source, the rechargeable battery to charge to the first charge capacity. For example, the first charge capacity can be a threshold charge capacity (e.g., 85% charge capacity). Accordingly, the controller 106 can cause the rechargeable battery 104 to charge to the threshold charge capacity, as the full charge capacity (e.g., 100% charge capacity) is not imperative since the appointment is at a location with a power source 108. Preventing the rechargeable battery 104 from being at the full charge capacity while connected to the power source can prevent stress on the rechargeable battery 104, which can extend the lifecycle of the rechargeable battery.

In some examples, the controller 106 can generate a notification in response to the appointment being in a location with a power source 108. The notification can alert a user that the rechargeable battery 104 is not being charged to the full charge capacity as a power source 108 exists at the location of the appointment. The notification can be displayed for the user via a display of the computing device 102, transmitted to a mobile device of the user, etc.

In some examples, the appointment may be in a location without a power source 108. In such an example, the controller 106 can cause, in response to the appointment being at a location without the power source 108, the rechargeable battery 104 to charge to the second charge capacity. For example, the second charge capacity can be a full charge capacity (e.g., 100% charge capacity). Accordingly, the controller 106 can cause the rechargeable battery 104 to charge to the full charge capacity, allowing the user to utilize the full charge capacity of the rechargeable battery 104 as the user transits with the computing device 102 while the computing device 102 is disconnected from a power source 108.

The controller 106 can cause the rechargeable battery 104 to charge to the second charge capacity a predetermined amount of time before the appointment. The predetermined amount of time can be based on a time of the appointment, an amount of time to charge the rechargeable battery 104 from the first charge capacity to the second charge capacity, an amount of time to transit from a current location of the computing device 102 to a location of the appointment, and/or a rate at which the rechargeable battery 104 is charged, as is further described herein.

The controller 106 can determine an amount of time to charge the rechargeable battery 104 from the first charge capacity to the second charge capacity (e.g., the full charge capacity). In some examples, the first charge capacity can be the threshold charge capacity (e.g., 85% charge capacity), and the controller 106 can determine an amount of time to charge the rechargeable battery 104 from the threshold capacity to the second charge capacity to be 10 minutes. In some examples, the first charge capacity can be an intermediate charge capacity (e.g., 45% charge capacity), and the controller 106 can determine an amount of time to charge the rechargeable battery 104 from the current capacity to the second charge capacity to be 45 minutes.

The controller 106 can determine an amount of time to transit from a current location of the computing device 102 to a location of the appointment. The controller 106 can determine a current location of the computing device 102 using a global positioning system (GPS) included on the computing device 102, a network connection such as a wired or wireless network relationship, Bluetooth, etc. Further, the controller 106 can determine a location of the appointment which can be included in appointment details associated with the appointment. Accordingly, the controller 106 can determine an amount of time to transit from the determined current location of the computing device 102 to the determined location of the appointment.

The controller 106 can cause the rechargeable battery 104 to charge from the first charge capacity to the second charge capacity at a particular predetermined time. The particular time can be based on a time of the appointment, the amount of time to charge the rechargeable battery 104 from the first charge capacity to the second charge capacity, and/or the amount of time to transit from the current location of the computing device 102 to the location of the appointment.

For example, the controller 106 can determine that an appointment included on the schedule at 12 PM does not have a power source 108, that the amount of time to charge the rechargeable battery 104 from the first charge capacity to the second charge capacity is 45 minutes, and that the amount of time to transit from the current location of the computing device 102 to the location of the appointment (e.g., a conference room) is 10 minutes. Accordingly, the controller 106 can cause the rechargeable battery 104 to charge to the second charge capacity at least 45 minutes before the scheduled 12 PM appointment (e.g., 11:15 AM) in order to allow enough time for the rechargeable battery 104 to charge to the second charge capacity.

As another example, the controller 106 can determine that an appointment included on the schedule at 12 PM does not have a power source 108, that the amount of time to charge the rechargeable battery 104 from the first charge capacity to the second charge capacity is 45 minutes, and that the amount of time to transit from the current location of the computing device 102 to the location of the appointment (e.g., an offsite location) is 55 minutes. The amount of time to transit to the location of the appointment may be determined based on geographic proximity, traffic conditions on roads between the current location of the computing device 102 and the location of the appointment, etc. Accordingly, the controller 106 can cause the rechargeable battery 104 to charge to the second charge capacity at least 55 minutes before the scheduled 12 PM appointment (e.g., 11:05 AM) in order to allow enough time for the rechargeable battery 104 to charge to the second charge capacity.

In some examples, the controller 106 can cause the rechargeable battery 104 to charge to the second charge capacity a predetermined amount of time before the appointment based on a rate at which the rechargeable battery 104 is charged. For example, a predetermined charge rate may be selected such that the controller 106 can cause the rechargeable battery 104 to charge to the second charge capacity a particular amount of time before the appointment according to the charge rate. For instance, the predetermined charge rate may be a particular percentage of charge per unit of time. The controller 106 can cause the rechargeable battery 104 to charge to the second charge capacity a predetermined amount of time before the appointment based on a current charge capacity of the rechargeable battery 104 (e.g., 45%) and the predetermined charge rate (e.g., 0.5% charge per minute). Although the predetermined charge rate is described above as being 0.5% per minute, examples of the disclosure are not so limited. For example, the predetermined charge rate can be any other unit of charge per unit of time.

In some examples, an appointment may be removed from the schedule. For example, the appointment may be canceled by the appointment organizer, a user of the computing device 102 may no longer be able to attend the appointment, etc. Accordingly, the controller 106 can prevent the rechargeable battery 104 from being charged to the second charge capacity in response to the appointment being removed from the schedule.

In some examples, the controller 106 can determine a schedule associated with the user identity that may include an appointment which occurs before the controller 106 is able to cause the rechargeable battery 104 to charge to the first charge capacity or the second charge capacity. In such an example, the controller 106 can modify the first charge capacity and/or second charge capacity, as is further described herein.

In some examples, the first charge capacity may be specified as 85%, the controller 106 may determine an appointment without a power source 108 is scheduled for 3:00 PM, the current charge capacity is 50% and the current time is 2:30 PM. Based on a particular charge rate, the controller 106 may not have enough time to cause the rechargeable battery 104 to be able to charge to the second charge capacity (e.g., 100%). Accordingly, the controller 106 can change the second charge capacity to a charge capacity that may be less than the full charge capacity such that the controller 106 is able to cause the rechargeable battery 104 to charge as much as possible prior to the time of the appointment or prior to a time a user departs to transit from a current location of the computing device 102 to a location of the appointment.

In some examples, the first charge capacity may be specified as 85%, the controller 106 may determine an appointment with a power source 108 is scheduled for 3:00 PM, the current charge capacity is 50% and the current time is 2:30 PM. Since the appointment includes a power source 108, the controller 106 can cause the rechargeable battery 104 to charge to the first charge capacity (e.g., 85%).

In some examples, the first charge capacity may be specified as 85%, the controller 106 may determine a first appointment with a power source 108 is scheduled for 3:00 PM and a second appointment without a power source is scheduled for 3:15 PM, the current charge capacity is 50% and the current time is 2:30 PM. Based on a particular charge rate, the controller 106 may not have enough time to cause the rechargeable battery 104 to be able to charge to the second charge capacity (e.g., 100%) from the first charge capacity (e.g., 85%) between the first appointment and the second appointment. Accordingly, the controller 106 can change the first charge capacity to a charge capacity that may be closer to the full charge capacity such that the controller 106 is able to cause the rechargeable battery 104 to charge to the full charge capacity in the timeframe. For example, the controller 106 may change the first charge capacity from 85% to 90% so that the rechargeable battery can maintain a lesser charge capacity but still have enough time to charge to a full charge capacity prior to the second appointment (e.g., without the power source) prior to the time of the second appointment or prior to a time a user departs to transit from a current location of the computing device 102 to a location of the second appointment.

In some examples, the controller 106 can determine an unscheduled event in which the computing device 102 is disconnected from a power source 108. As used herein, the term “unscheduled event” refers to an action that takes place which does not have a set time for occurrence. The controller 106 can determine the unscheduled event based on past unscheduled events via machine learning. As used herein, the term “machine learning” refers to data analysis that automates an analytical model building by relying on patterns and inference. For example, the controller 106 can record unscheduled events over a predetermined period of time. The predetermined period of time may be for a week, a month, a year, etc. The controller 106 can analyze past unscheduled events during the predetermined period of time in which the computing device 102 is disconnected from a power source 108 and make a prediction as to when an unscheduled event in which the computing device 102 is disconnected from a power source 108 may occur in the future, as is further described herein.

For example, the controller 106 may record an unscheduled event (e.g., a user disconnecting the computing device 102 from the power source 108 at or around 5 PM) over a period of 3 months. The user may disconnect the computing device 102 as the user decides to go home from work and bring the computing device 102 with them, for example. During the time period, the user may disconnect the computing device 102 at 4:57 PM on a first day, disconnect the computing device 102 at 4:49 PM on a second day, disconnect the computing device 102 at 5:05 PM PM on a third day, etc.

The controller 106 can determine, via machine learning using the times at which the user disconnected the computing device 102 over the 3 month period of time, that an unscheduled event is occurring at 5 PM every day (e.g., that the user is disconnecting the computing device 102 from a power source 108 at or around 5 PM). In this manner, a schedule can be modified, such as by adding an event to the schedule used to determine when to charge the rechargeable battery or increasing the amount of time needed to start charging the rechargeable battery based on early disconnects from a power source prior to an event. Machine learning may include, for instance, artificial neural networks, decision trees, support vector machines, and/or Bayesian networks, among other types of machine learning models.

The controller 106 can cause, based on the determined unscheduled event, the rechargeable battery 104 to be charged from a first charge capacity (e.g., a threshold charge capacity, an intermediate charge capacity, etc.) to the second charge capacity. As described above, the controller 106 can cause the rechargeable battery 104 to be charged to the second charge capacity at a particular time based on an amount of time to charge the rechargeable battery 104 to the second charge capacity. For example, the controller 106 can cause the rechargeable battery 104 to be charged to the second charge capacity at 4:30 PM in response to the controller 106 determining it can take 30 minutes to charge the rechargeable battery 104 to the second charge capacity, among other examples.

Although the unscheduled event is described above as being a user disconnecting the computing device 102 from a power source 108 at the end of a workday, examples of the disclosure are not so limited. For example, the unscheduled event may be the user disconnecting the computing device 102 from a power source 108 at any other time, for recurring appointments, etc.

Schedule-based charging of batteries, according to the disclosure, can allow for a rechargeable battery to be charged to a threshold charge capacity that is less than a full charge capacity until an appointment in which a computing device having the rechargeable battery has to be disconnected from a power source. Preventing the rechargeable battery from being charged to and maintained at a full charge capacity while the computing device is connected to a power source can prevent the rechargeable battery from being stressed, which can prevent the total amount of charge capacity of the rechargeable battery from diminishing, extending the lifecycle of the rechargeable battery.

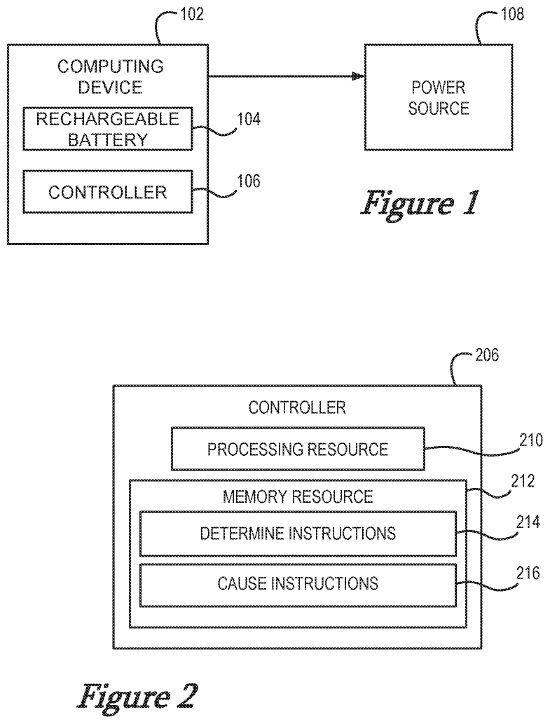

FIG. 2 illustrates an example of a controller 206 for schedule-based charging of batteries consistent with the disclosure. As described herein, the controller 206 may perform functions related to schedule-based charging of batteries. Although not illustrated in FIG. 2, the controller 206 may include a processor and a machine-readable storage medium. Although the following descriptions refer to a single processor and a single machine-readable storage medium, the descriptions may also apply to a system with multiple processors and multiple machine-readable storage mediums. In such examples, the controller 206 may be distributed across multiple machine-readable storage mediums and the controller 206 may be distributed across multiple processors. Put another way, the instructions executed by the controller 206 may be stored across multiple machine-readable storage mediums and executed across multiple processors, such as in a distributed or virtual computing environment.

Processing resource 210 may be a central processing unit (CPU), a semiconductor-based microprocessor, and/or other hardware devices suitable for retrieval and execution of machine-readable instructions 214, 216 stored in a memory resource 212. Processing resource 210 may fetch, decode, and execute instructions 214, 216. As an alternative or in addition to retrieving and executing instructions 214, 216, processing resource 210 may include a plurality of electronic circuits that include electronic components for performing the functionality of instructions 214, 216.

Memory resource 212 may be any electronic, magnetic, optical, or other physical storage device that stores executable instructions 214, 216 and/or data. Thus, memory resource 212 may be, for example, Random Access Memory (RAM), an Electrically-Erasable Programmable Read-Only Memory (EEPROM), a storage drive, an optical disc, and the like. Memory resource 212 may be disposed within controller 206, as shown in FIG. 2. Additionally, memory resource 212 may be a portable, external or remote storage medium, for example, that causes controller 206 to download the instructions 214, 216 from the portable/external/remote storage medium.

The controller 206 may include instructions 214 stored in the memory resource 212 and executable by the processing resource 210 to determine a schedule associated with a user identity. For example, a user may have appointments on a schedule associated with the user's user identity. The controller 206 can, accordingly, determine whether the schedule includes any appointments.

The controller 206 may include instructions 216 stored in the memory resource 212 and executable by the processing resource 210 to cause, in response to an appointment included on the schedule associated with the user identity, a rechargeable battery of a computing device to charge from a first charge capacity to a second charge capacity. The first charge capacity can be an intermediate charge capacity or a threshold charge capacity, and the second charge capacity can be a full charge capacity. The appointment may be in a location such that a user has to disconnect the computing device from a power source to bring the computing device with to the appointment. In anticipation, the controller 206 can cause the rechargeable battery of the computing device to charge to the second charge capacity such that a user can utilize a fully charged rechargeable battery to power the computing device.

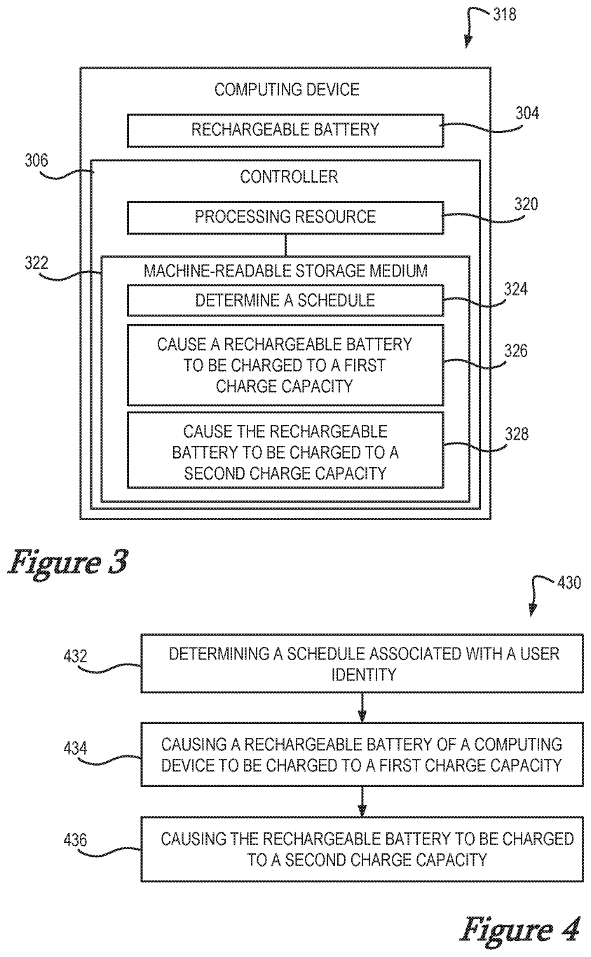

FIG. 3 illustrates a block diagram of an example system 318 consistent with the disclosure. In the example of FIG. 3, system 318 includes a computing device 302 having a rechargeable battery 304 and a controller 306. The controller 306 can include a processing resource 320 and a machine-readable storage medium 322. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 320 may be a central processing unit (CPU), microprocessor, and/or other hardware device suitable for retrieval and execution of instructions stored in machine-readable storage medium 322. In the particular example shown in FIG. 3, processing resource 320 may receive, determine, and send instructions 324, 326, and 328. As an alternative or in addition to retrieving and executing instructions, processing resource 320 may include an electronic circuit comprising a number of electronic components for performing the operations of the instructions in machine-readable storage medium 322. With respect to the executable instruction representations or boxes described and shown herein, it should be understood that part or all of the executable instructions and/or electronic circuits included within one box may be included in a different box shown in the figures or in a different box not shown.

Machine-readable storage medium 322 may be any electronic, magnetic, optical, or other physical storage device that stores executable instructions. Thus, machine-readable storage medium 322 may be, for example, Random Access Memory (RAM), an Electrically-Erasable Programmable Read-Only Memory (EEPROM), a storage drive, an optical disc, and the like. The executable instructions may be “installed” on the system 318 illustrated in FIG. 3. Machine-readable storage medium 322 may be a portable, external or remote storage medium, for example, that allows the system 318 to download the instructions from the portable/external/remote storage medium. In this situation, the executable instructions may be part of an “installation package”. As described herein, machine-readable storage medium 322 may be encoded with executable instructions associated with schedule-based charging of batteries.

Determine instructions 324, when executed by a processor such as processing resource 320, may cause system 318 to determine a schedule associated with a user identity. For example, a user may have appointments on a schedule associated with the user's user identity. The system 318 can, accordingly, determine whether the schedule includes any appointments.

Cause instructions 326, when executed by a processor such as processing resource 320, may cause system 318 to cause the rechargeable battery 304 of the computing device 302 to be charged to a first charge capacity. For example, the first charge capacity can be a threshold charge capacity, such as 85% charge capacity of the rechargeable battery 304. Charging the rechargeable battery 304 to a threshold charge capacity that is less than the full charge capacity of the rechargeable battery 304 when the computing device 302 is connected to a power source can prevent stressing of the battery and extend the lifecycle of the rechargeable battery 304. The system 318 can cause the rechargeable battery 304 to charge from an intermediate charge capacity to the first charge capacity.

Cause instructions 328, when executed by a processor such as processing resource 320, may cause system 318 to cause, in response to an appointment being included on the schedule associated with the user identity, the rechargeable battery 304 of the computing device 302 to charge from the first charge capacity to a second charge capacity, wherein the second charge capacity is greater than the first charge capacity. For example, the appointment may be in a location such that a user has to disconnect the computing device 302 from the power source to bring the computing device 302 with to the appointment. In anticipation, the system 318 can cause the rechargeable battery 304 of the computing device 302 to charge to the second charge capacity such that a user can utilize a fully charged rechargeable battery 304 to power the computing device 302 when the computing device 302 is disconnected from the power source and the rechargeable battery 304 is powering the computing device 302.

FIG. 4 illustrates an example of a method 430 for schedule-based charging of batteries consistent with the disclosure. For example, method 430 can be performed by a controller (e.g., controller 106, 206, 306, previously described in connection with FIGS. 1-3, respectively).

At 432, the method 430 includes determining, by a controller, a schedule associated with a user identity. For example, a user may have appointments on a schedule associated with the user's user identity. The controller can, accordingly, determine whether the schedule includes any appointments.

At 434, the method 430 includes causing, in response to no appointments being included in the schedule associated with the user identity, a rechargeable battery of a computing device to be charged to a first charge capacity. For instance, if there are no appointments in which the computing device has to utilize a rechargeable battery to power the computing device, the controller can cause the rechargeable battery to be charged to the first charge capacity. The first charge capacity can be a threshold charge capacity, such as 85% charge capacity of the rechargeable battery. Charging the rechargeable battery to a threshold charge capacity that is less than the full charge capacity of the rechargeable battery when the computing device is connected to a power source can prevent stressing of the battery and extend the lifecycle of the rechargeable battery.

The method 430 can include causing the rechargeable battery to be charged from an intermediate charge capacity to the first charge capacity in response to the computing device being plugged into a power source. For example, a user may be utilizing the computing device while it is not plugged into a power source and as a result, the charge capacity of the rechargeable battery can be depleted. Once a user connects the computing device to a power source, the controller can cause the rechargeable battery to charge from an intermediate charge capacity (e.g., whatever charge capacity the rechargeable battery is at when the computing device is connected to the power source) to the first charge capacity when there are no determined appointments in which the computing device is not able to connect to a power source.

At 436, the method 430 includes causing, in response to an appointment being included in the schedule associated with the user identity, the rechargeable battery to be charged to a second charge capacity, where the second charge capacity corresponds to a full charge capacity of the rechargeable battery. For example, the appointment may be in a location such that a user has to disconnect the computing device from the power source to bring the computing device with to the appointment. In anticipation, the controller can cause the rechargeable battery of the computing device to charge to the second charge capacity such that a user can utilize a fully charged rechargeable battery to power the computing device when the computing device is disconnected from the power source and the rechargeable battery is powering the computing device.

The method 430 can include causing the rechargeable battery to be charged from an intermediate charge capacity to the second charge capacity in response to the computing device being plugged into a power source and a different appointment being included in the schedule associated with the user identity. For example, a user may be utilizing the computing device while it is not plugged into a power source and as a result, the charge capacity of the rechargeable battery can be depleted. Once a user connects the computing device to a power source, the controller can cause the rechargeable battery to charge from an intermediate charge capacity (e.g., whatever charge capacity the rechargeable battery is at when the computing device is connected to the power source) to the second charge capacity when there is another determined appointment in which the computing device is not able to connect to a power source.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A controller, comprising:
a processing resource; and
a memory resource storing non-transitory machine-readable instructions to cause the processing resource to:
determine a schedule associated with a user identity; and
cause, in response to an appointment included on the schedule associated with the user identity, a rechargeable battery of a computing device to charge from a first charge capacity to a second charge capacity.

2. The controller of claim 1, wherein the second charge capacity is greater than the first charge capacity.

3. The controller of claim 1, wherein the second charge capacity of the rechargeable battery corresponds to a full charge capacity of the rechargeable battery.

4. The controller of claim 1, including instructions to cause the rechargeable battery of the computing device to charge to the second charge capacity a particular amount of time before the appointment.

5. The controller of claim 1, wherein the rechargeable battery is a lithium-ion battery.

6. The controller of claim 1, wherein:
the computing device is connected to a power source; and
the computing device is powered by the power source while the controller causes the rechargeable battery to be charged to the second charge capacity.

7. A computing device, comprising:
a rechargeable battery; and
a controller comprising a processing resource that executes non-transitory machine-readable instructions stored in a machine-readable storage medium to cause the controller to:
determine a schedule associated with a user identity;
cause a rechargeable battery of the computing device to be charged to a first charge capacity; and
cause, in response to an appointment being included on the schedule associated with the user identity, the rechargeable battery of the computing device to charge from the first charge capacity to a second charge capacity, wherein the second charge capacity is greater than the first charge capacity.

8. The computing device of claim 7, wherein the controller executes the instructions to prevent the rechargeable battery from being charged to the second charge capacity in response to the appointment being removed from the schedule.

9. The computing device of claim 7, wherein the controller executes the instructions to determine at least one of:
an amount of time to charge the rechargeable battery from the first charge capacity to the second charge capacity; and
an amount of time to transit from a current location of the computing device to a location of the appointment.

10. The computing device of claim 9, wherein the controller executes the instructions to cause, at a particular time, the rechargeable battery to charge from the first charge capacity to the second charge capacity, wherein the particular time is based on at least one of:
a time of the appointment;
the amount of time to charge the rechargeable battery from the first charge capacity to the second charge capacity; and
the amount of time to transit from the current location of the computing device to the location of the appointment.

11. The computing device of claim 7, wherein the controller executes the instructions to determine whether the appointment is in a location without a power source.

12. The computing device of claim 11, wherein the controller executes the instructions to:
cause, in response to the appointment being at a location without a power source, the rechargeable battery to charge to the second charge capacity; and
cause, in response to the appointment being at a location with a power source, the rechargeable battery to charge to the first charge capacity.

13. A method, comprising:
determining, by a controller, a schedule associated with a user identity;
causing, in response to no appointments being included in the schedule associated with the user identity, a rechargeable battery of a computing device to be charged to a first charge capacity; and
causing, in response to an appointment being included in the schedule associated with the user identity, a rechargeable battery of a computing device to be charged to a second charge capacity, wherein the second charge capacity corresponds to a full charge capacity of the rechargeable battery.

14. The method of claim 13, wherein the method includes causing the rechargeable battery to be charged from an intermediate charge capacity to:
the first charge capacity in response to the computing device being plugged into a power source;
the second charge capacity in response to the computing device being plugged into a power source and a different appointment being included in the schedule.

15. The method of claim 13, wherein the method includes:
determining, by the controller via machine learning, an unscheduled event in which the computing device is disconnected from a power source based on past unscheduled events in which the computing device was disconnected from the power source; and
causing, based on the unscheduled event, the rechargeable battery to be charged to the second charge capacity.
